(19) United States
(12) Patent Application Publication
(10) Pub. No.: US 2026/0045739 A1
(43) Pub. Date: Feb. 12, 2026

(54) CONNECTOR

(71) Applicant: Yazaki Corporation, Tokyo (JP)

(72) Inventors: Atsunori IWASHITA, Shizuoka (JP); Masayuki ISHIGAMI, Shizuoka (JP)

(73) Assignee: Yazaki Corporation, Tokyo (JP)

(21) Appl. No.: 19/290,567

(22) Filed: Aug. 5, 2025

(30) Foreign Application Priority Data
Aug. 6, 2024 (JP) 2024-129614

(51) Int. Cl. H01R 13/629

(52) U.S. Cl. CPC H01R 13/62944; H01R 13/62938

(57) ABSTRACT

A connector includes a housing including a fitting part that is fittable inside a mating housing; and a terminal configured to have connection part arranged inside the mating housing in a state where the fitting part is fitted with the mating housing, wherein in the housing, a lever configured to be rotationally movable, and a first slide member configured to move in a direction crossing a fitting direction of the fitting part by rotational movement of the lever to cause the fitting part to fit inside the mating housing are arranged, and at a part of the fitting part where the connection part is exposed, a second slide member configured to be arranged to cover the connection part and to move toward a housing side by movement of the first slide member to cause the connection part to be exposed inside the mating housing is arranged.

### CROSS-REFERENCE TO RELATED APPLICATIONS

The present application is based on, and claims priority from the prior Japanese Patent Application No. 2024-129614, filed on Aug. 6, 2024, the entire contents of which are incorporated herein by reference.

### TECHNICAL FIELD

The present disclosure relates to a connector.

### BACKGROUND

Conventionally, a connector has a transaxle as a housing with a terminal block as a fitting part which is fittable inside a PCU as a mating housing. Also, a connector is known that has a bus bar, as a terminal, which is housed in a transaxle, and whose connection part is exposed from a terminal block and is arranged inside the PCU in a state where the terminal block is fitted with the PCU (see Patent Document 1). In this connector, the connection part of the bus bar is arranged in an inverter of the PCU by fitting the terminal block to the PCU, and the bus bar and the inverter can be electrically connected by using bolts (see JP2020-78971 A).

### SUMMARY OF THE INVENTION

In the connector as described in Patent Document 1, the connection part of the terminal is arranged to be exposed from the fitting part. Thus, for example, when the fitting part is fitted to a mating housing, the danger of a worker touching the connection part may increase.

The present disclosure has been made in view of the issue in the prior art. It is an object of the present disclosure to provide a connector capable of maintaining safety.

A connector according to an embodiment includes a housing including a fitting part that is fittable inside a mating housing; and a terminal configured to be housed in the housing, to have a connection part exposed from the fitting part, and to have the connection part arranged inside the mating housing in a state where the fitting part is fitted with the mating housing, wherein in the housing, a lever configured to be rotationally movable, and a first slide member configured to move in a direction crossing a fitting direction of the fitting part by rotational movement of the lever to cause the fitting part to fit inside the mating housing are arranged, and at a part of the fitting part where the connection part is exposed, a second slide member configured to be arranged to cover the connection part and to move toward a housing side by movement of the first slide member to cause the connection part to be exposed inside the mating housing is arranged.

According to the present disclosure, it is possible to provide a connector capable of maintaining safety.

### BRIEF DESCRIPTION OF DRAWINGS

FIG. 1 is a side view before a fitting part of a connector according to the present embodiment is fitted to a mating housing.

FIG. 2 is a side view immediately before the fitting part of the connector according to the present embodiment is fitted to the mating housing.

FIG. 3 is a side view when the fitting part of the connector according to the present embodiment has been fitted to the mating housing.

FIG. 4 is a side view of a first slide member of the connector according to the present embodiment.

FIG. 5 is a side view of a second slide member of the connector according to the present embodiment.

### DETAILED DESCRIPTION OF THE INVENTION

A connector according to the present embodiment will be described in detail below with reference to the drawings. Note that dimensional ratios in the drawings are exaggerated for convenience of the description and are sometimes different from actual ratios.

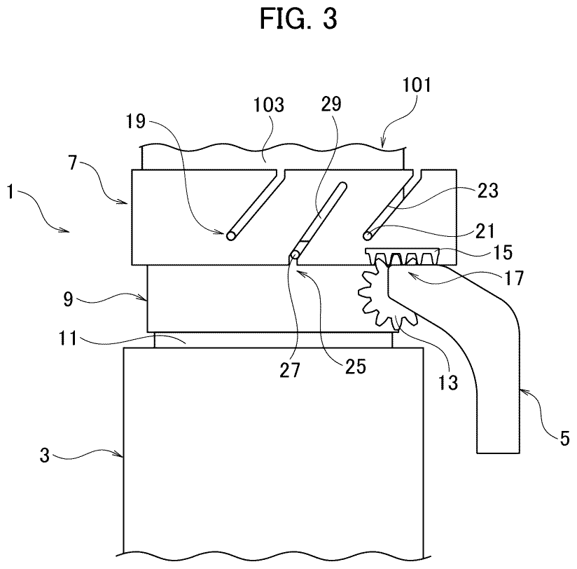

As illustrated in FIG. 3, a connector 1 according to the present embodiment electrically connects two electrical components (not illustrated), such as a power supply and a device, or a device and another device. The connector 1 is electrically connected to one electrical component, for example. The connector 1 is fittable with a mating connector 101 electrically connected to the other electrical component. The mating connector 101 includes, for example, a mating housing 103 and a mating terminal (not illustrated) housed in the mating housing 103. The mating housing 103 is provided with an opening part (not illustrated) for electrically connecting the mating connector 101 to the connector 1 by exposing the mating terminal and fastening a bolt (not illustrated) from the outside, for example. The connector 1 includes a housing 3 which is fittable with the mating housing 103, and a terminal (not illustrated) which is housed in the housing 3 and is electrically connected to the mating terminal. In the connector 1, the mating terminal and the terminal are arranged in the opening part of the mating housing 103 by fitting the housing 3 to the mating housing 103. The mating terminal and the terminal arranged in the opening part are electrically connected by fastening a bolt, and thus two electric components are electrically connected.

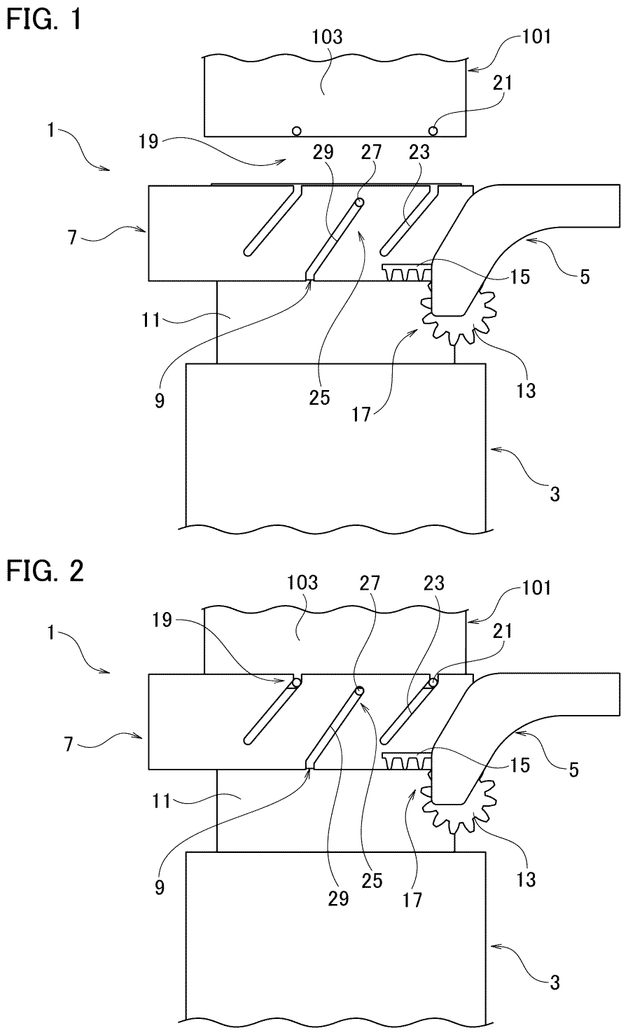

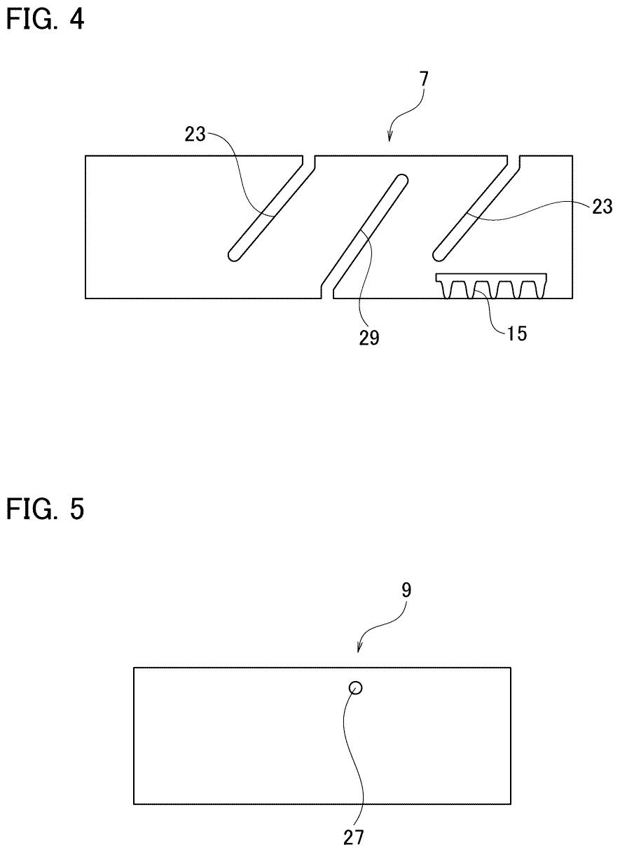

As illustrated in FIGS. 1 to 5, the connector 1 includes the housing 3, the terminal, a lever 5, a first slide member 7, and a second slide member 9.

The housing 3 illustrated in FIGS. 1 to 3 is made from, for example, an electrical insulating material, such as a synthetic resin. The housing 3 is formed in a housing shape where a terminal can be housed inside. The housing 3 is provided with a fitting part 11 that is fittable inside the mating housing 103.

Although not illustrated, the terminal is made from, for example, an electroconductive material, such as a metal material, and is formed in a plate like a bus bar. Multiple terminals are housed in the housing 3. One end of the terminal is electrically connected to, for example, a terminal part of an electric wire electrically connected to one electric component, and thus the terminal is electrically connected to one electric component. The other end of the terminal is a connection part which is arranged to be exposed from the fitting part 11 when the terminal is housed in the housing 3. The connection part exposed from the fitting part 11 is arranged to overlap with the mating terminal in a state where the fitting part 11 is fitted with the mating housing 103. The connection part overlapped with the mating terminal includes a part facing the opening part of the mating housing 103. In the part of the connection part facing the opening part, for example, a through hole where a bolt can be inserted is formed, and the mating terminal and the terminal are electrically connected by the bolt inserted through the through hole and fastened.

The lever 5 illustrated in FIGS. 1 to 3 is made from, for example, an electrical insulating material, such as a synthetic resin. The lever 5 includes a pair of side walls and a connection wall connecting the pair of side walls and is formed in a U-shape. For example, end parts of the pair of side walls opposite to the connection wall are supported by a shaft (not illustrated) provided in the housing 3, and the lever 5 is rotationally movable relative to the housing 3. The lever 5 rotationally moves between a standby position (see FIG. 2) before the fitting part 11 and the mating housing 103 are fitted, and a completion position (see FIG. 3) after the fitting part 11 and the mating housing 103 are fitted. Gear members 13 are integrally fixed to the ends of the pair of side walls on the opposite side of the connection wall of the lever 5. The gear members 13 are each provided with multiple meshing teeth on their outer periphery and rotate integrally with the lever 5 by rotatable movement of the lever 5.

The first slide member 7 illustrated in FIGS. 1 to 4 is made from, for example, an electrical insulating material, such as a synthetic resin. The first slide member 7 is formed in a cylindrical shape larger than the outer shape of the mating housing 103 so that the mating housing 103 can be housed inside. A length of the first slide member 7, which is orthogonal to a direction fitting of the fitting part 11, is set in such a manner that while the fitting part 11 is fitted, the first slide member 7 is movable in a state where the mating housing 103 is housed inside, in a direction crossing the fitting direction. The first slide member 7 is arranged on a fitting part 11 side of the housing 3 to be movable in a direction crossing the fitting direction of the fitting part 11 (here, a direction orthogonal to the fitting direction). The first slide member 7 is arranged to cover the connection part of the terminal exposed from the fitting part 11. Thus, in a state before the fitting part 11 is fitted with the mating housing 103, the connection part of the terminal is not exposed to the outside, and safety can be maintained. The first slide member 7 is arranged outside the mating housing 103 in a state where the fitting part 11 is fitted with the mating housing 103. Thus, the connection part of the terminal exposed from the fitting part 11 can be arranged inside the mating housing 103 in a state where the fitting part 11 is fitted with the mating housing 103. Rack parts 15 which mesh with the gear members 13 are each provided on the outer surfaces facing the pair of gear members 13 provided integrally with the levers 5 of the first slide member 7. In each of the rack parts 15, multiple meshing teeth which mesh with the meshing teeth of each of the gear members 13 are arranged along a direction where the first slide member 7 moves.

The gear members 13 and the rack parts 15 configure a conversion part 17 which moves the first slide member 7 in a direction (here, a direction orthogonal to the fitting direction) crossing the fitting direction and a disengaging direction of the fitting part 11 by rotational movement of the levers 5. Multiple conversion parts 17 (here, two) are provided between the levers 5 and the first slide member 7. The conversion parts 17 move the first slide member 7 toward the right relative to the housing 3 when the levers 5 are rotationally moved from the standby position toward the completion position. On the other hand, the conversion parts 17 move the first slide member 7 toward the left relative to the housing 3 when the levers 5 are rotationally moved from the completion position toward the standby position. By providing the conversion parts 17, rotational movement of the levers 5 can be converted into an operation force of moving the first slide member 7.

Multiple (here, four) cam parts 19 are provided between the first slide member 7 and the mating housing 103. The cam parts 19 each include a cam pin 21 and a cam groove 23. The cam pin 21 is formed protruding from the outer surface of the mating housing 103. The cam groove 23 is provided in the first slide member 7, has a bottomed groove shape opening on the mating housing 103 side, and is formed by a through hole through which the cam pin 21 can move. The cam groove 23 is inclined to draw the cam pin 21 by movement of the first slide member 7 when the fitting part 11 is fitted. The cam part 19 is configured such that when the fitting part 11 is fitted with the mating housing 103, the cam pin 21 is arranged in an opening part of the cam groove 23. The cam pin 21 arranged in the opening part of the cam groove 23 moves along the cam groove 23 inside the cam groove 23 to be drawn into the cam groove 23 through movement of the first slide member 7 by rotational movement of the lever 5. The fitting part 11 is fitted to be drawn into the mating housing 103 by the movement of the cam pins 21 in the cam grooves 23. By providing the cam part 19, the fitting operation force between the fitting part 11 and the mating housing 103 can be reduced.

The second slide member 9 illustrated in FIGS. 1 to 3, and 5 is made from an electrical insulating material, such as a synthetic resin. The second slide member 9 is formed in a cylindrical shape larger than the outer shape of the fitting part 11 so that the fitting part 11 can be housed inside. The outer shape of the second slide member 9 is smaller than that of the first slide member 7 so as to be housed inside the first slide member 7. The second slide member 9 is arranged on a fitting part 11 side of the housing 3 so as to be movable along the fitting direction and the detaching direction of the fitting part 11. The second slide member 9 is arranged inside the first slide member 7 to cover the connection part of the terminal exposed from the fitting part 11. Thus, in a state before the fitting part 11 is fitted with the mating housing 103, the connection part of the terminal is not exposed to the outside, and safety can be maintained. When the fitting part 11 is fitted with the mating housing 103, the second slide member 9 moves toward the housing 3 side by the movement of the first slide member 7 to expose the connection part of the terminal to the inside of the mating housing 103. Thus, in the state where the fitting part 11 is fitted with the mating housing 103, the connection part of the terminal exposed from the fitting part 11 can be arranged inside the mating housing 103. Therefore, the connection part of the terminal is not exposed to the outside from before the fitting part 11 is fitted with the mating housing 103 until the fitting part is fitted, and safety can be maintained by preventing a worker from touching the connection part of the terminal, for example.

Multiple (here, two) guide parts 25 for moving the second slide member 9 by movement of the first slide member 7 are provided between the second slide member 9 and the first slide member 7. The guide parts 25 each have a guide pin 27 and a guide groove 29. The guide pin 27 is formed protruding from the outer surface of the second slide member 9. The guide groove 29 is provided in the first slide member 7, has a bottomed groove shape opening on the housing 3 side, and is formed by a through hole through which the guide pin 27 can move. The guide groove 29 is inclined at the same inclination angle as the cam groove 23 so that the guide pin 27 comes out from the inside of the guide groove 29 when the fitting part 11 is fitted. In the guide part 25, the guide pin 27 is arranged at the bottom of the guide groove 29 in a state before the fitting part 11 is fitted. The guide pin 27 arranged at the bottom of the guide groove 29 moves along the guide groove 29 toward an opening part of the guide groove 29 by the movement of the first slide member 7 when the fitting part 11 is fitted. The second slide member 9 moves toward the housing 3 side by the movement of the guide pin 27 along the guide groove 29, and the connection part of the terminal is arranged in the mating housing 103. By providing the guide parts 25, the second slide member 9 can be moved in conjunction with the movement of the first slide member 7.

The connector 1 is provided with the housing 3 having the fitting part 11, which is fittable inside the mating housing 103. The connector 1 is provided with a terminal which is housed in the housing 3, and whose connection part is exposed from the fitting part 11 and is arranged inside the mating housing 103 in a state where the fitting part 11 is fitted with the mating housing 103. In the housing 3, the lever 5, which is rotationally movable, and the first slide member 7, which moves in a direction crossing the fitting direction of the fitting part 11 by rotational movement of the lever 5, and fits the fitting part 11 inside the mating housing 103 are arranged. The second slide member 9, which is arranged so as to cover the connection part of the terminal and moves toward the housing 3 side by movement of the first slide member 7 to expose the connection part to the inside of the mating housing 103, is arranged at a part where the connection part is exposed.

Since the second slide member 9 is arranged so as to cover the connection part of the terminal exposed from the fitting part 11, the connection part of the terminal is not exposed to the outside, and safety can be maintained, in a state before the fitting part 11 is fitted to the mating housing 103. When the fitting part 11 is fitted to the mating housing 103, the second slide member 9 moves toward the housing 3 side by movement of the first slide member 7 to expose the connection part of the terminal to the inside of the mating housing 103. Thus, in a state where the fitting part 11 is fitted to the mating housing, the connection part of the terminal exposed from the fitting part 11 can be arranged inside the mating housing 103.

Therefore, in the connector 1, the connection part of the terminal is not exposed to the outside, and safety can be maintained, from before the fitting part 11 is fitted with the mating housing 103 until the fitting part 11 is fitted.

In addition, the first slide member 7 is arranged to cover the connection part exposed from the fitting part 11 and is arranged outside the mating housing 103 in a state where the mating housing 103 and the fitting part 11 are fitted.

Thus, in a state before the fitting part 11 is fitted to the mating housing 103, the connection part of the terminal is not exposed to the outside by means of the first slide member 7 and the second slide member 9, and safety can be maintained. The first slide member 7 is arranged outside the mating housing 103 in a state where the fitting part 11 is fitted to the mating housing 103. Thus, the connection part of the terminal exposed from the fitting part 11 can be arranged inside the mating housing 103 in the state where the fitting part 11 is fitted to the mating housing.

The conversion parts 17 for moving the first slide member 7 by rotational movement of the lever 5 are provided between the lever 5 and the first slide member 7. The cam parts 19 for pulling the cam pins 21 into the cam grooves 23 by the movement of the first slide member 7 and fitting the fitting part 11 inside the mating housing 103 are provided between the mating housing 103 and the first slide member 7. The guide parts 25 for moving the guide pins 27 along the guide grooves 29 by the movement of the first slide member 7 and moving the second slide member 9 toward the housing 3 side are provided between the first slide member 7 and the second slide member 9.

By providing the conversion parts 17 between the levers 5 and the first slide member 7, rotational movement of the levers 5 can be converted into operation force of moving the first slide member 7. In the cam parts 19, the fitting part 11 is fitted inside the mating housing 103 by movement of the cam pins 21 in the cam grooves 23. By providing the cam parts 19, the operation force for fitting the fitting part 11 and the mating housing 103 can be reduced. In the guide parts 25, by movement of the guide pins 27 in the guide grooves 29, the second slide member 9 moves toward the housing 3 side, and the connection part of the terminal is arranged in the mating housing 103. By providing the guide parts 25, the second slide member 9 can be moved in conjunction with the movement of the first slide member 7.

Although the present embodiment has been described above, the present embodiment is not limited to these descriptions, and various modifications are possible within the scope of the gist of the present embodiment.

For example, in the cam parts, although the cam pins are provided in the mating housing, and the cam grooves are provided in the first slide member, the cam pins may be provided in the first slide member, and the cam grooves may be provided in the mating housing. Similarly, in the guide parts, the guide pins may be provided in the first slide member, and the guide grooves may be provided in the second slide member.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a housing including a fitting part that is fittable inside a mating housing; and
a terminal configured to be housed in the housing, to have a connection part exposed from the fitting part, and to have the connection part arranged inside the mating housing in a state where the fitting part is fitted with the mating housing, wherein
in the housing, a lever configured to be rotationally movable, and a first slide member configured to move in a direction crossing a fitting direction of the fitting part by rotational movement of the lever to cause the fitting part to fit inside the mating housing are arranged, and
at a part of the fitting part where the connection part is exposed, a second slide member configured to be arranged to cover the connection part and to move toward a housing side by movement of the first slide member to cause the connection part to be exposed inside the mating housing is arranged.

2. The connector according to claim 1, wherein the first slide member is configured to be arranged to cover the connection part exposed from the fitting part, and to be arranged outside the mating housing in a state where the mating housing and the fitting part are fitted.

3. The connector according to claim 1, wherein
a conversion part configured to move the first slide member by rotational movement of the lever is provided between the lever and the first slide member,
a cam part configured to pull a cam pin in a cam groove by movement of the first slide member to cause the fitting part to be fitted inside the mating housing is provided between the mating housing and the first slide member, and
a guide part configured to move a guide pin along a guide groove by movement of the first slide member to move the second slide member toward the housing side is provided between the first slide member and the second slide member.
